(19) United States
(12) Patent Application Publication
(10) Pub. No.: US 2001/0037317 A1
(43) Pub. Date: Nov. 1, 2001

(54) Method and system for dynamic interactive queries

(76) Inventors: Ray Freiwirth, New York, NY (US); Eric J. Maloney, Somers, NY (US)

Correspondence Address: HENRY M FEIEREISEN, 350 FIFTH AVENUE, SUITE 3220, NEW YORK, NY, 10118

(21) Appl. No.: 09/842,600

(22) Filed: Apr. 25, 2001

Related U.S. Application Data
(60) Provisional application No. 60/199,705, filed on Apr. 26, 2000.

(51) Int. Cl. H04K 1/00

(52) U.S. Cl. 705/74

(57) ABSTRACT

A process is disclosed for creating and operating a community, wherein members exchange information securely, anonymously, and under established privacy and community rules in order to either place or find validated resources among members of the community or their designated proxy agents. This is typically useful in chaotic markets in which information is presented in a number of formats with fragmented service or product offerings. As the community is created, each member added into the community is authenticated and the information supplied validated as needed in order to become a full member of the community. Members can attribute different levels of privacy on the information entered via a standard interface. The members can also use a comparative valuation of the submitted information to update their information and obtain a better match with community standards.

### CROSS-REFERENCES TO RELATED APPLICATIONS

This application the benefit of prior filed provisional application, Appl. No. 60/199,705, filed Apr. 26, 2000, pursuant to 35 U.S.C. 119(e).

### BACKGROUND OF THE INVENTION

The invention is directed to a computer-implemented system to provide secure queries between members and authorized parties in a defined community with dynamic rule generation, and more particularly, to provide data validation and data valuation in Internet-based job placement applications.

The Internet-based job placement industry suffers from an unregulated and insecure exchange of non-standardized information to parties and through forums. As a result, only three percent of all individuals seeking employment acknowledge that they used Internet-based services to place themselves in that position. In most electronic job placement or job referral services, either the potential employee or employer can be inundated with documents to the point of information overload. It is not uncommon for potential employers to automatically receive dozens, if not hundreds of electronic resumes daily, for just a single job posting, rendering the whole process nearly useless. Few electronic placement companies can provide privacy to workers who want to anonymously post resumes. In other words, open systems lack secure processes to guard privacy, anonymity or security of personal information. Often an individual who posts a resume will be contacted by interested placement agencies well after the person has either found work or has decided to not change jobs and is powerless to stop the solicitation.

In other situations, an employee of a company may post a resume online in order to try and assess his or her market value by hoping to quietly entertain other employment prospects, only to have co-workers or employers discover his/her resume on the Internet, causing awkward and potentially career threatening situations. There are also no dependable valuation techniques available today through electronic media because there is no standard or de facto standard for job descriptions or skills.

More recently, electronic placement services companies, such as Monster.com, have begun to provide free posting for potential workers and charge fees to potential employers interested in searching through the postings. In most cases, key word searches are used to scan the content of postings. Due to the non-standardized and voluntary nature of most industry information related to worker's skills, experience, titles, compensation and other important job related information, there is little to no reliable market analysis related to these variables. Some placement services offer privacy controls for data, but do not allow for authorization of specific members or groups to view these data based on privacy settings.

It would therefore be desirable to provide a closed community with accepted standards as applied to the format and content of data being entered into the system, allowing for normalization and accurate reporting and market analysis of system input. It would also be desirable to build trust among users and between the users and the system by providing a robust validation system that allows for a more rapid exchange of relevant and valuable information. Complete anonymity and security of personal information should also be provided by setting clear rules of data storage and communication among members of the community, along with data validation, valuation and dynamics rule updates.

### SUMMARY OF THE INVENTION

The invention is directed to a process for the creation and operation of a community, wherein members exchange information securely, anonymously, and under established privacy and community rules in order to either place or find validated resources among members of the community or their designated proxy agents or other authorized parties. This is typically useful in chaotic markets in which information is presented in a number of formats with fragmented service or product offerings. As the community is created, each member added into the community is authenticated and the information supplied validated as needed in order to become a full member of the community. Members can attribute different levels of privacy on the information they entered via standard interfaces, thereby providing the level of entitlement of that data to other members or proxy agents to view. Information and communications between members is done in an anonymous manner, so that information detail cannot be tied to any one particular member. The proxy agent or another referee is appointed as an authority to audit events that occur between members in the community to ensure that the members follow the prescribed rules, with the referee acting as an adjudicator when the members' actions required it. In addition, all validated data for the members can be valuated against the total community's information in a secure and anonymous manner, allowing a member to determine where they stand relative to all other members and what values differentiate them from the other members. The community is capable of assimilating new data entries from members or proxy agents so that the ability to valuate member capabilities is enabled for any new values found at threshold levels.

According to one aspect of the invention, a process for comparative valuation of information includes establishing a community of validated members wherein the community is administered by a referee. A member of the community submits the information to the community in response to a field in a standard query; whereafter the referee validates the information and compares the information with other validated information submitted by other members of the community. The member receives from the referee the comparative valuation of the submitted information in relation to the other information. The anonymity of the other members and of the information itself is retained.

According to another aspect of the invention, a process is disclosed for anonymously matching information meeting criteria between members in a community. In the process, a querying member initiates a query, and an Item ID is creates for the query, wherein the Item ID does not reveal the identity of the querying member. A separate Item ID is created for each queried member who successfully meets the criteria of the query. The process further includes generating a metrics for the querying members and queried members meeting the criteria to indicate a degree of success of queries, with the generated metrics being communicated to the querying member.

Embodiments of the invention may include one or more of the following features. The member of the community can be validated based on initial information, which can include a mailing address, an email address, and credit card information, submitted by the member to the referee. The member can submits the information by populating fields in a form and/or can supply non-standardized input information, for example, in memo form. The referee can extract the non-standardized input and, if a predetermined fraction of the other members also provide a substantially identical non-standardized input, can add a filed corresponding to the non-standardized input to the standard query. Likewise, the referee can remove a field from the standard query if a predetermined fraction of the members fails to populate the field when submitting the information.

The member can use the comparative valuation of the submitted information to update the information submitted to the community. The community can be made up of an employment service, a health service, a travel and/or rental/lease service, with the submitted information relating to a skill, a need and/or another requirement of the member.

When a member queries the database, the query may identify new or modified fields of information. A community database is searched for interest indicators, for example related to similar queries by other members. A member can anonymously query another member, with the identity of the members shielded from one another by an Item ID. The queried member is free to respond with an Interest or Non-Interest Indicator. All information can be tagged so as to be viewable by the members of the community depending on the attached tag.

The referee overseeing the community can be a designated member of the community, a designated proxy agent and/or another authorized party that is not part of the community.

### BRIEF DESCRIPTION OF THE DRAWING

Other features and advantages of the present invention will be more readily apparent upon reading the following description of a preferred exemplified embodiment of the invention with reference to the accompanying drawing, in which:

FIG. 1 is a schematic diagram of a client connected to a server via a network;

FIG. 2 is an exemplary GUI progress window;

FIG. 3 is an exemplary valuation screen of member data;

FIG. 4 is an exemplary data interface with posting results;

FIG. 5 depicts an exemplary iterative normalization process;

FIG. 6 depicts an exemplary member query process;

FIG. 7 depicts an automated matching process;

FIG. 8 shows schematically a process for querying one member by another member;

FIG. 9 depicts a basic data validation process;

FIG. 10 depicts a proxy data validation process;

FIG. 11 depicts an advanced data validation process; and

FIG. 12 depicts a data valuation process.

### DETAILED DESCRIPTION OF PREFERRED EMBODIMENTS

Throughout all the Figures, same or corresponding elements are generally indicated by same reference numerals.

The invention is directed to a system and method for secure queries over a network. In particular, the system and method described herein can be used, for example, for secure anonymous data queries in a job placement environment, wherein user data can be validated, valuated (ranked against previously computed averages), and the data relevance can be dynamically updated with increased granularity based on a member's input.

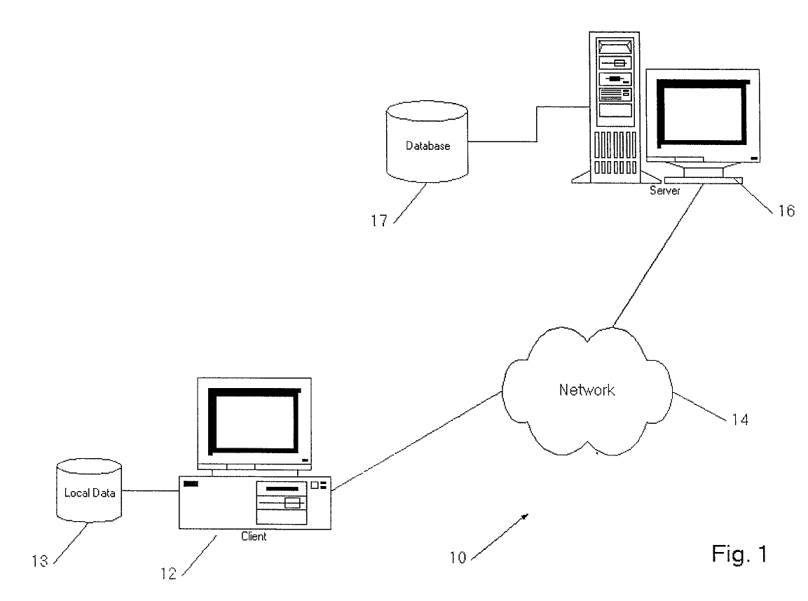

Referring first to FIG. 1 illustrates a system 10 which includes a client system 12 with a local database 13, which may be internal to the client system 12, and an agency server 16, such as a server of a trusted party, for example, a job placement agency, with the server 16 being connected through a network 14, such as the Internet or a LAN, to the client system 12. The server 16 connects to a proprietary database 17 maintained by the server 16 for securely storing user identities and user data, as will be described in detail below.

For the depicted system, the client system 12 can be any suitable computer system such as a PC workstation, a handheld computing device, a wireless communication device, or any other such device, equipped with a network client capable of accessing a network server and interacting with the server 16 to exchange information with the server 16. The network client may be a web client, such as a web browser that can include the Netscape web browser, the Microsoft Internet explorer web browser, the Lynx web browser, or a proprietary web browser, or web client that allows the user to exchange data with a web server, and ftp server, a gopher server, or same other type of network server. Optionally, the client 12 and the server 16 rely on an unsecured communication path, such as the Internet 14, for accessing services on the remote server 16. To add security to such a communication path, the client and the server can employ a security system, such as any of the conventional security systems that have been developed to provide to the remote user a secured channel for transmitting data aver the Internet. One such system is the Netscape secured socket layer (SSL) security mechanism that provides to a remote user a trusted path between a conventional web browser program and a web server.

The server 16 may be supported by a commercially available server platform, such as a Sun Sparc™ system running a version of the Unix operating system and running a server capable of connecting with, or transferring data between, any of the client systems. In the embodiment of FIG. 1, the server 16 includes a web server, such as the Apache web server or any suitable web server. The operation of the web server component at the server can be understood more fully from Laurie et al., Apache The Definitive Guide, O'Reilly Press (1997).

The server 16 may also include components that extend its operation to accomplish the transactions described herein, and the architecture of the server 16 may vary according to the application. For example, the web server may have built in extensions, typically referred to as modules, to allow the server to exchange information with the client and to operate on such information, or the web server may have access to a directory of executable files, each of which files may be employed for performing the operations, or parts of the operations, such as files required to create and encrypt ID's and data, as described in the present application. The client system 12 depicted in FIG. 1 is to be understood as being representative of a plurality of client systems 12 that can communicate with the server 16 or with one another via the server 16.

A user interface, such as a dynamic HTML page, interfaces the user with the server's secure database that is designed to be easily accessible and navigatable. In an exemplary embodiment, the user, upon deciding to join a community, such as the exemplary job placement community described hereinafter, proceeds to the login screen and provides personal contact information, for example, mailing address and email address, and, if required by the server, also credit card information necessary to process an initial membership fee. Welcoming information may be displayed on the user's HTML page, or for enhanced security, a welcome email may be sent to the new member, which contains a confirmation identification number. The user is typically required to reply to the welcome notice, including the confirmation number, using the email address earlier provided as their primary contact email address. After this procedure is carried out the user can go online for the first time and begin entering information and using services.

With each logon, the user's progress in providing data is presented on the user's dynamic HTML home page provided by the server. The user can then choose to continue to add more detailed information on existing forms, be notified of new fields of information that can be populated, or be allowed to continue on to use any service without needing to provide additional information before proceeding.

In a job placement environment, the user will most likely be required to enter specific information related to available jobs, such as his/her technical skill set. The technical skills data input follows the same logical flow as any other data input. The model allows for the operation of queries and use of services with a minimum of data entry, but scales to a level of great detail based upon the user's readiness to provide additional information for greater use of marketing information that resides in the agency's database, as described below.

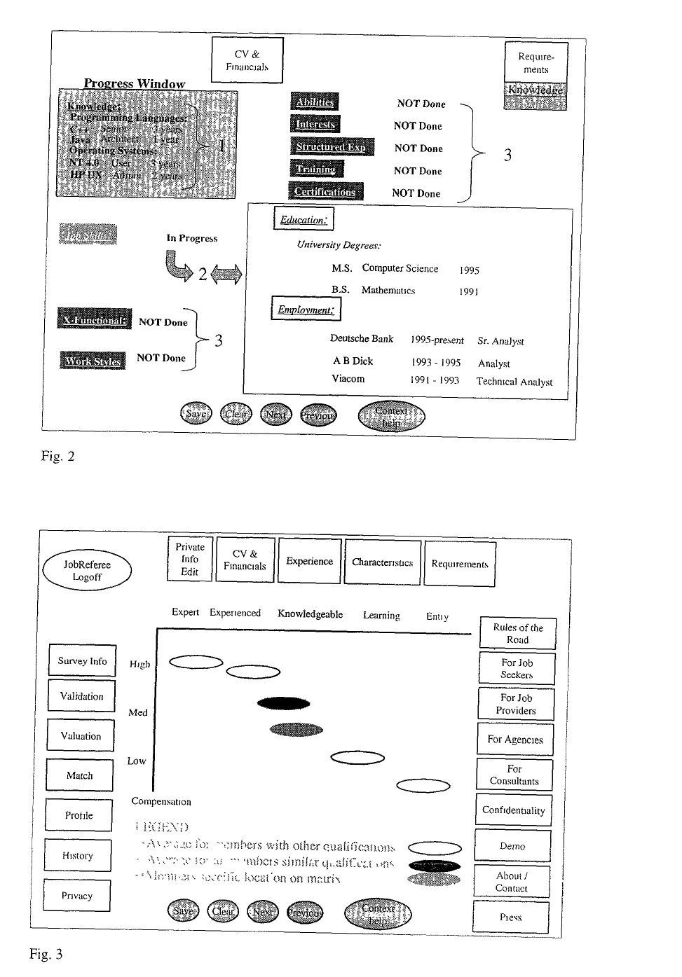

As depicted in FIG. 2, a user interface in form of a progress window will allow the member to see what data has been entered and validated [1], what data is in the process of being entered and not validated [2], and that data that still needs to be entered [3]. Additionally, this screen will allow the member to go to any data element that is shown by clicking on that item. The member can exit at any time, and all data entered up to set point would be saved on behalf of the member. With each successive logon, the member will be given the option of being placed directly back to the place of the last entry or going to a location that the system is indicating needs some attention by the member. Members can view status of data entry from the dynamic HTML home page that the system generates for each member.

Once the system has validated data provided by a member, the member can then leverage the valuation services in the system in relation to validated data fields. The validation process takes information from an opportunity seeker or an opportunity provider and validates fields of information for their accuracy. The valuation process compares and ranks the validated data the give the opportunity seeker a sense of how he/she compares in education, skills, etc., with an average of other job seekers. The information placed into the field is considered suspect until validated, and will be flagged as such. The agency's database provides the opportunity to adjust the ability to provide accurate valuations as well as focused queries to the amount of information provided by the applicant. The validation process will be described in more detail below.

Referring now to FIG. 3, the member has decided to run a valuation against the data that was input in this session. The input can be ranked with respect to certain preset criteria, such as expertise, knowledge and skills level, as shown on the horizontal axis, and given high, medium and low value marks, and shown on the vertical axis. The screen will also show the member's specific location on the matrix with respect to the average for workers with other or similar qualifications. The member then has the ability to click on any of the displayed matrix items to get more detail with regard to compensation, education, certification, location and other quantifying distinctions that define the comparative average of the other workers. This will greatly help the member determine his/her fair value, while at the same time showing the path that can be used by the member to become more valuable, i.e., seeing what factors the more compensated objects contain.

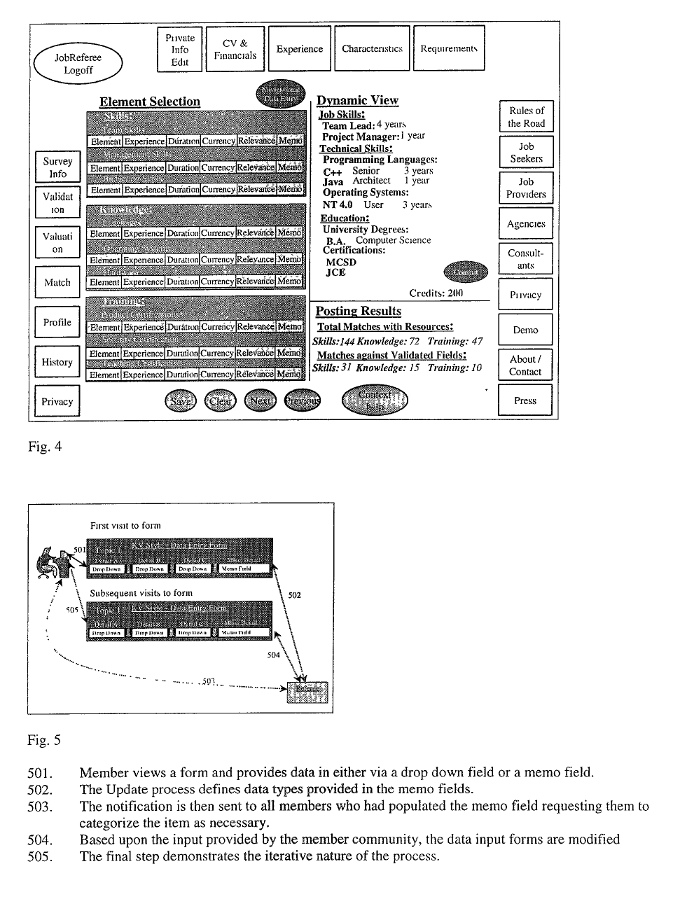

In response to the results of FIG. 3, a member can provide more detailed data in the same or in a future session. FIG. 4 is a screen shot of an exemplary user interface which consists of the following major 3 elements:

An element selection section: for selecting and qualifying the fields of information that will constitute an opportunity posting;

A dynamic view section: for providing a formatted view of the information already entered into the system; and

A posting results section: for proving query results of entities that match posting criteria, once the finalized posting is committed to the system.

In one embodiment of the user interface (not shown), the following question may appear following all the questions that comprise a mandatory element: “Would you like to add additional opportunity information that is not required by system and is not part of the basic validation process?” There may be a toggle input option of “Yes” or “No”. If the member responds “Yes”, then another dynamic data interface may be displayed.

Members are encouraged to provide increasingly more granular detail of information, subtly and overtly, in order to build a more useful in dynamic knowledge database, as described below. For example, as shown in the schematic diagram of FIG. 5, a member can view a form and provide data in either a drop down field or a memo field, path 501. The database searches for patterns in the data captured in the added memo fields and updates the database, for example at scheduled intervals, path 502. A notification can then be sent to those members who previously populated the memo field with a request to categorize the items in the memo fields, path 503. The data input forms can then be modified based upon the input provided by the member community, path 504. For example, the data can be identified as viable for continuing on the agency's process if a type of data meets a custom threshold criteria, such as having been entered into the memo field by one percent or more of the member community that provided information for the topic. This process is iterative, as indicated by path 505.

A notification template is populated with the data type culled from the memo field. The notification is then sent to all members who have populated the memo field with a piece of information. The appropriate members are informed of the significance of the data type within the community and, through the use of voting buttons, are requested to categorize the item in one of several ways, for example as a drop down item in a detail field in the original topic, as a new detail field type in the original topic, as a new topic area, or as a subject of a newsgroup discussion to define the item in question.

Based on the input provided by the member community, the content of the detail drop-down lists, the type of the detail drop counts and the type of topics available for data input are revised to reflect the information normalization achieved by the agency's process. The members will be asked to updates the information, since the system does not automatically modify member data in order to maintain data integrity and validated data.

Similarly, the agency's process will regularly scan drop-down lists to determine which data types have not been leveraged by the member community, identifying data types for removal from the lists. Moreover, the process is iterative in nature and will regularly hone the data types made available to members.

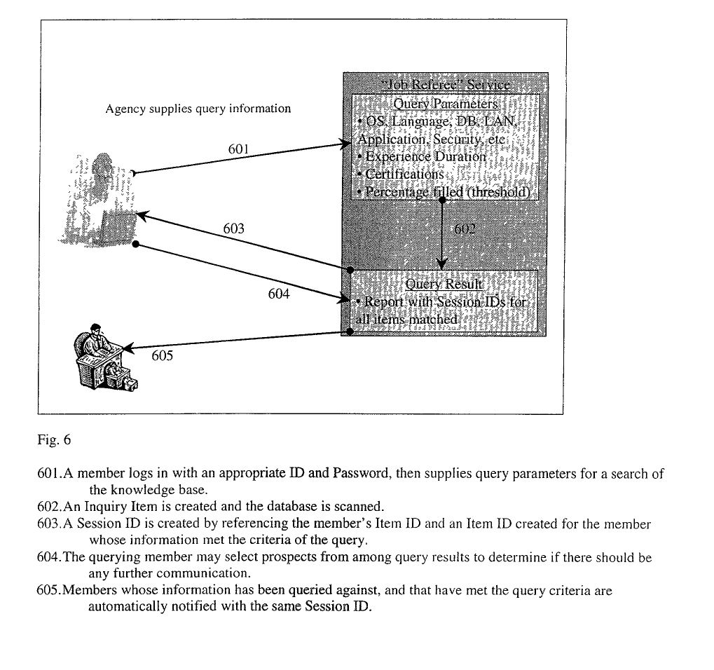

Referring now to FIG. 6, the process allows members of the community to query the proprietary server database 17 for members who meet a defined set of criteria, path 601. When the query is launched, path 602, the system tracks the request by creating an Item ID, which does not reveal the identity of the member, and which tags and accompanies this unique request. This is done in order to provide the results back to the querying member while shielding the requester's Member ID from any other members who made might want to reference the query. If the query finds prospective members who meet the criteria specified by the agency, a separate Item ID is created for each member who successfully meets the criteria. This shields the member's true identity while providing an association between the member and the query. A session identifier number (Session ID) can be created by amalgamating the Item ID of the requester's query with the Item ID of the member's query, path 603. In addition, inventories of Item ID's that include the query transaction can be generated on the dynamic HTML home page of both members, without directly or indirectly revealing any information about the other member. It should be noted that when query data returned equates to a common denominator of an item, it might compromise the identity of the owner of information, therefore that query may be blocked by the owner of the data, requiring a response from the referee).

If a member chooses to pursue contact with another member, path 604, an anonymous communication can take place by use of the Session ID created by the query process. If the querying member of the communicated to member chooses not to pursue communication, for whatever reason, his or her anonymity is maintained, thanks to the session ID.

Whenever a query is carried out as presented in FIG. 6, an Item ID of the query is automatically generated for the member who successfully meets the query criteria. Members whose information has been queried against, and that have met the query criteria are automatically notified with the same Session ID, path 605.This will allow the system to generate metrics for the query member to indicate how well he/she is faring against queries in the system. The metrics may be graphically displayed in a window on the querying member's computer display screen and may have an appearance similar to that of the window depicted in FIG. 3.

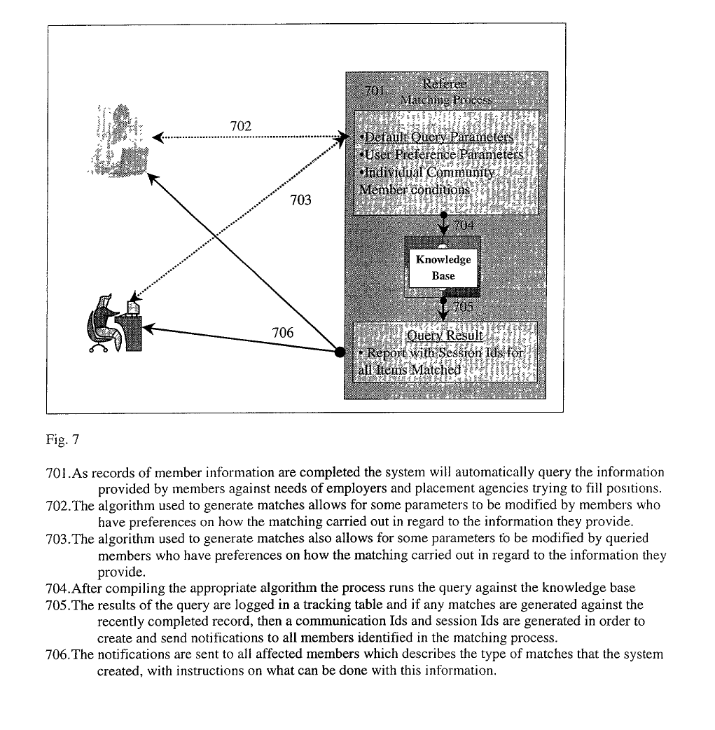

The system is designed to automatically run queries against member data at the end of each member's session. The query identifies new or modified fields of information and then searches the knowledge base for interest indicators related to the member's information. An automated matching process is depicted in FIG. 7.

As seen in FIG. 7, as records of member information are completed, the system will automatically query the information provided by members against needs of employers and placement agencies trying to fill positions, 701. The algorithm used to generate matches allows for some parameters to be modified by members who have preferences on how the matching is carried out in regard to the information they provide, path 702. The algorithm used to generate matches also allows for some parameters to be modified by queried members who have preferences on how the matching carried out in regard to the information they provide, path 703. After compiling the appropriate algorithm, the process runs the query against the knowledge base, path 704. The results of the query are logged in a tracking table and if any matches are generated against the recently completed record, then new Session IDs are generated in order to create and send notifications to all members identified in the matching process, path 705. The notifications are sent to all affected members which describe the type of matches that the system created, with suggestions on how to take advantage of this information, path 706. The query results can be provided to the member either via an email, or as a notification on the member's dynamic HTML page in the form of standard template that explains all the query parameters and how they meet the desired criteria.

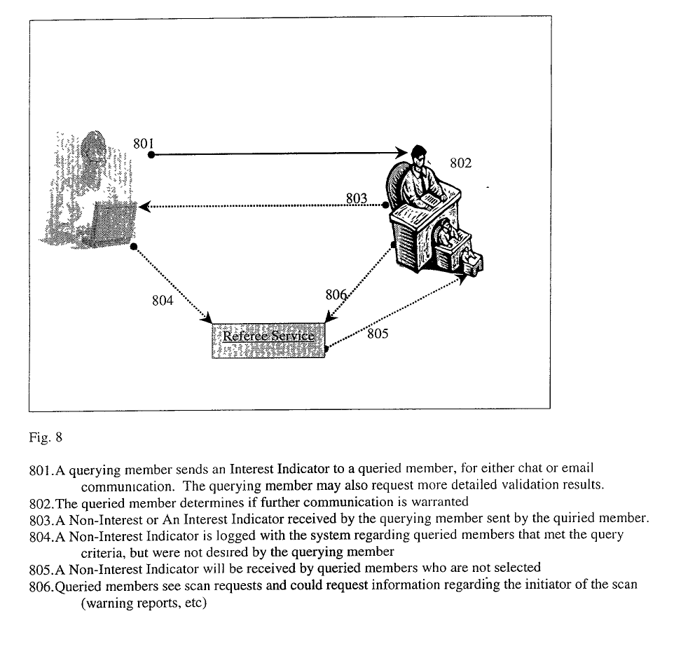

Referring now to FIG. 8, a querying member, after receiving the results of a query, may want to contact particular queried members in order to better determine the viability for potential matches of certain opportunities, path 801. Correspondence may be initiated by sending an Interest Indicator by the querying member to the desired community members, for example, by email or chat. The querying member, in the same correspondence, may request particular clarifications or disclosures of additional information. Due to the anonymous nature of the correspondence, the receiving member may choose to continue the correspondence anonymously, using the Session ID that was generated for sending the Interest Indicator, path 801, or he/she may opt to reply with a Non-interest Indicator, thereby ending the correspondence between the two members, path 803.

For members who may have met the criteria of the query, but were rejected by the querying member, the Non-Interest Indicator would be generated and logged with the system, path 804. The system would automatically generate a message to all members who were not selected for continued correspondence by the querying member, but who did meet the criteria of the query, path 805.

Any member who receives either an Interest or a Non-Interest Indicator could request any viewable information about the querying member from the system, path 806. This is made possible through use of the Session ID created along with either the Interest or Non-interest Indicator. The dual nature of Session ID's protects the anonymity of both members.

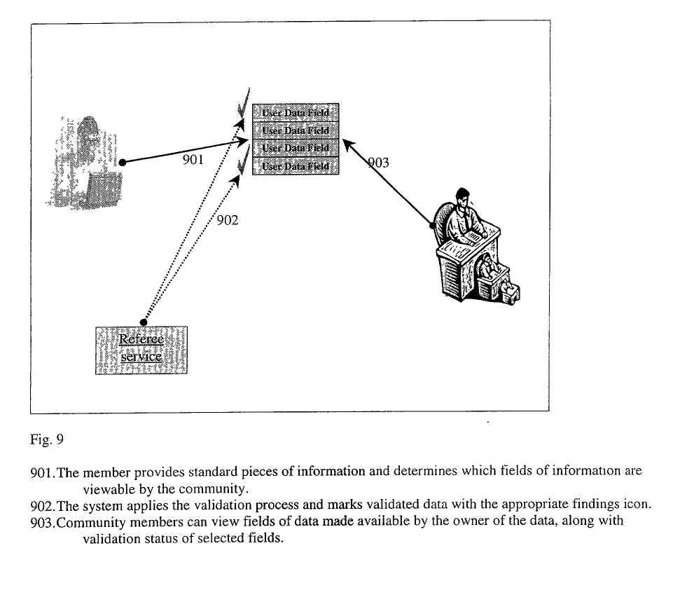

As depicted in FIG. 9, one of the requirements for membership, each member allows the system to perform a basic validation procedure against a minimal number of pieces of information, path 901. The validation process takes information from an opportunity seeker or an opportunity provider and validates fields of information for their accuracy, path 902. How, when and to whom information is disclosed within the community is at the discretion of the owner of the information. Members can view fields of data made available by the owner of the data, along with validation status of selected fields, path 903.

When the member enters information into the system, he/she will have an opportunity to tag how the information may be viewed in the community (privacy indicator). Every field of information has a default privacy tag that the member can see and that will take affect unless modified by the member. In addition to the value entered by the member into a field, another tag for that field can be generated by the system, indicating the validation state of the data field. For example, a member may enter the name of his/her most current employer and allow this information to be viewed by any member of the community.

The data could be in one of the following states:

Not validated

Under investigation with no result yet determined

Unverifiable

Determined inaccurate

Determined valid

Once the data are entered, a viewing setting is set and a validation tag is assigned by the system, any of following scenarios could occur in regard to a particular field of information:

The member could choose to reveal the item to the general community. All members could then see the field's value as well as the item's validation tag

The member could choose to hide the item from the general community, who would see nothing related to the item

The member could hide the item from the general community, yet reveal the validation tag, so the community members could not see the field value, but would know there is a value and know the item's validation status

The member could set the viewing properties on an item to reveal it only to particular queries. In this case, a querying agency might see the value and its validation tag

The member could set the viewing properties on the item to reveal it only to the system running to queries. In this case, the querying agency would not see the value and the field, but could find that the member meets the criteria of a query based on the value of the field

The member could hide the value of the field and reveal it on an individual basis, based upon a Session ID. In this case, another member of the community could view the value of the field and see the item's validation tag.

The member cannot suppress the viewing of the validation tag in any scenario where the value of the field is viewable. Also, if a query is run against the value of a field that the owner allows to be queried, the validation tag cannot be suppressed from the querying agent (in case it is made part of the criteria of the query).

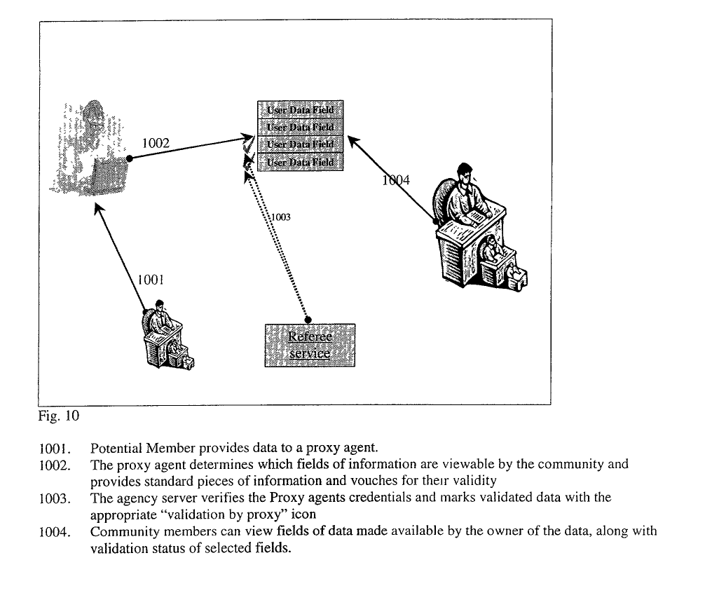

Alternatively, as seen in FIG. 10, the validity of pieces of information may be vouched for by a member of the community (proxy) in lieu of the system carrying out the data validation procedure. In this case, the item could be specially tagged as having its value validated by a proxy procedure.

A member provides data to an authorized party (proxy agent) in the community, path 1001. The proxy agent determines which fields of information are viewable by the community and provides standard pieces of information and vouches for their validity, path 1002. The agency server verifies the Proxy agent's credentials and marks validated data with an appropriate “validation by proxy” icon, path 1003. Community members can view fields of data made available by the owner of the data, along with validation status of selected fields, path 1004.

With proxy validation, the system and the proxy agent share responsibility for data accuracy. The system requires that the validation agent demonstrate the capacity to perform data validation of member information it provides to the system. In addition, the system provides avenues of recourse for community members to challenge the validity of validated information that entered into the system via a proxy agent. If it is determined that the proxy agent either provides false information or did not exercise due diligence in validating information entered into the system, then the proxy agent could either be restricted in their use of the system, or possibly have their membership in the community revoked.

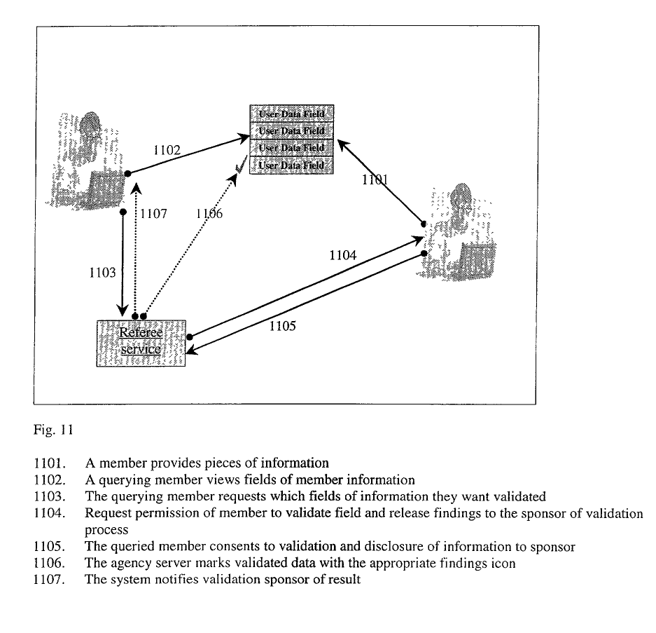

Alternatively, as depicted in FIG. 11, an advanced validation process could be envisioned wherein a sponsor, other than the original owner of the information, would gain limited rights to validated information. For example, a member provides information in certain fields, path 1101, that a querying member views, path 1102. A querying member requests fields of information to be validated by the agency, path 1103. The agency requests permission to validate fields from the member who provided the information, and release these findings to the sponsor of validation process, path 1104. The queried member consents to validation and disclosure of information to the agency, path 1105. The agency server marks validated data with a suitable findings icon, path 1106, and the system notifies the validation sponsor of the result, path 1107.

In this case, an advanced validation tag could be suppressed from community view or even from the system when conducting a query. The information owner does not have the right to disassociate the Advanced Validation sponsor from the value entered into the field. If the information owner modifies the content of a field, the validation status automatically changes and the sponsor of the original validation is automatically notified.

Any member of the community can conduct a series of queries against system data to determine the valuation of information related to their own profiles. The content of each query will be restricted to the type of data the querying member has provided into the system. In order for the query to be run, the member must supply two criteria that can be cross-referenced to determine a valuation of the data, such as job title in a geographic region. The member can select custom criteria for each query. The parameters of the query will take into account conditions placed on information in the agency's database 17 by owners of the data or the system. Once the query is constructed, the system scans the query log table to check if identical queries have already been run. This will allow a historical reference to the querying member.

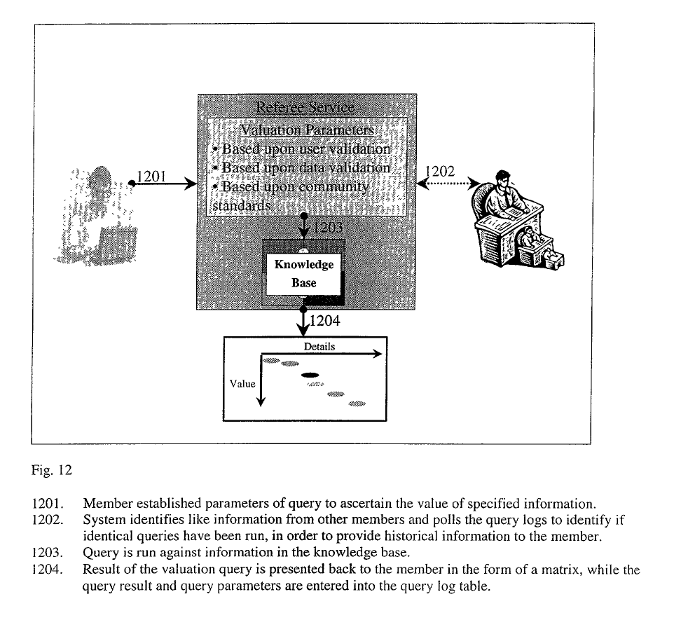

Referring now to FIG. 12, once the system completes the query, the results can be displayed to the member in the form of a matrix, together with the member's parameters of the query and parameters set by owners of data and the system, if applicable. For example, a member establishes and sends to the agency's system query parameters to ascertain the value of specified information, path 1201. In response, the system identifies like information from other members and polls the query logs to identify if identical queries have been run, in order to provide historical information to the member, path 1202. The query is run against information in the knowledge base, path 1203. The result of the valuation query is returned to the member in the form of a matrix, path 1204, while the query result and query parameters are entered into the query log table. The matrix has essentially the same form as the matrix depicted in and described in reference to FIG. 3.

If data owners have hidden fields from view, the query results would cite the percentage of data, based both upon hidden and viewable fields of data. Finally, the criteria and results of the query are entered into the query log table in order to build an exhaustive knowledge database for future queries to be compared against.

In summary, authentication and validation along with privacy and anonymity is provided to a market community. Members are brought together with efficient market matching capabilities. The member environment is adaptable in that the querying capability actually learns and updates the forms available to members based on common market requests.

While the invention has been disclosed in connection with the preferred embodiments shown and described in detail, various modifications and improvements thereon will become readily apparent to those skilled in the art. For example, the member may use a wizard to carry out the reporting process. An automated report build can give members the opportunity to choose data, templates, delivery medium and previews of output. Optionally, any member could allow an outside authorized party to load information directly from the database based on their privacy entitlement. For example, a member might allow an educational institution to fill in validated data directly to that member's data store. Or, another example might be an e-commerce company looking for information about this particular member and having the Member ID could be allowed to obtain the information. Or, a member filling out an e-commerce's web site information form might allow for specified validated information to be filled in automatically (where a connection and relationship is created between the server 16 connected to the proprietary database 17 and the web site needing the information) based on the giving of express entitlement to the data needed.

There are many other market areas in which this model of secure queries between members and authorized parties of a community for validated data and valuation of data can be used. In the case of the rental market, landlords would want to know that there is data that has been validated and valuation of renters for the landlord properties. There is also the travel market, where travel agents would be want to know travelers previous experiences, special needs and requirements from data that has been validated and valuated. Another example is the health community market, where members could keep their medical records on file in a secure manner, allowing health care agents (Doctors, Nurses, Dentists, plan administrators) to put validated data into the member's repository and obtain validated data as allowed. These are many more types of examples such as these where the current model extends.

While the invention has been illustrated and described as embodied in a method and system for dynamic interactive queries, it is not intended to be limited to the details shown since various modifications and structural changes may be made without departing in any way from the spirit of the present invention.

What is claimed as new and desired to be protected by Letters Patent is set forth in the appended claims:

What is claimed is:

1. A process for comparative valuation of information, comprising:
providing a community of validated members, said community administered by a referee,
a member submitting the information to the community in response to a field in a standard query,
the referee validating the information and comparing the information with other validated information submitted by other members of the community, while retaining the anonymity of the other members and of the information itself, and
the member receiving from the referee the comparative valuation of the submitted information in relation to other member's information.

2. The process of claim 1, wherein the member of the community is validated based on initial information submitted by the member to the referee.

3. The process of claim 2, wherein the initial information comprises at least one element selected from the group consisting of mailing address, email address, and credit card information.

4. The process of claim 1, wherein the member submits the information by at least partially populating fields in a form.

5. The process of claim 1, wherein submitting information further includes the member providing a non-standardized input, the referee extracting the non-standardized input and, if a predetermined fraction of the other members also provide a substantially identical non-standardized input, adding a filed corresponding to the non-standardized input to the standard query.

6. The process of claim 1, wherein the referee removes a field from the standard query if a predetermined fraction of the members fails to populate the field when submitting the information.

7. The process of claim 1, wherein the member uses the comparative valuation of the submitted information to update the information submitted to the community.

8. The process of claim 1, wherein the community is selected from employment service, health service, travel and rental/lease service.

9. The process of claim 8, wherein the submitted information relates to at least one of a skill, a need or requirement of the member.

10. A process for anonymously matching information meeting a criteria between members in a community, comprising:
a querying member initiating a query,
creating an Item ID for the query, which does not reveal the identity of the querying member,
creating a separate Item ID for each queried member who successfully meets the criteria,
creating a Session ID by amalgamating the Item ID of the querying member with the Item ID of the queried member meeting the criteria,
generating a metrics for the querying members and queried members meeting the criteria to indicate a degree of success of queries, and
communicating the generated metrics to the querying member.

11. The process of claim 10, wherein the query identifies new or modified fields of information and searches a community database for interest indicators related to the member's query.

12. The process of claim 10, further comprising the querying member or a queried member meeting the criteria modifying information according to preferences on how the matching is carried out in regard to the information, and if any matches are generated against the modified information, generating a new Session ID for sending notifications to all queried members identified in the modified matching process.

13. The process of claim 10, further comprising the querying member, after receiving the results of a query, electing to contact a particular queried members meeting the criteria, the contacted member responding with an Interest or Non-interest Indicator, and if responding with an Interest Indicator, continuing the contact with the querying member using a Session ID generated for transmission of the Interest Indicator.

14. The process of claim 13, further comprising generating a message to all members who met the criteria, but were not selected to be contacted by the querying member, with the not-selected members able to request viewable information about the querying member using the Session ID.

15. The process of claim 10, further including associating a privacy tag with the information, said privacy tag determining the “entitlement” of viewability of the information by the members or authorized parties of the community.

16. The process of claim 1, further including associating a privacy tag with the information, said privacy tag determining how the information may be viewed by the members of the community.

17. The process of claim 1, wherein the referee is a designated member of the community or a designated proxy agent or another authorized party outside the community.
